(19) United States
(12) Patent Application Publication
(10) Pub. No.: US 2021/0275377 A1
(43) Pub. Date: Sep. 9, 2021

(54) Flower Vase Cremation Urn (Vase Urn)

(71) Applicant: Simon Agar, Hillarys (AU)

(72) Inventor: Simon Agar, Hillarys (AU)

(21) Appl. No.: 17/024,757

(22) Filed: Sep. 18, 2020

Related U.S. Application Data
(60) Provisional application No. 62/984,775, filed on Mar. 3, 2020.

(51) Int. Cl. A61G 17/08; A61G 17/007

(52) U.S. Cl. CPC A61G 17/08; A61G 17/007

(57) ABSTRACT

A vase shaped storage container for cremated remains with a sealed threaded screw cap on the bottom, with the vase shaped storage container fitting fiat to the surface the base of the urn is positioned on, the threaded screw base opens to receive ashes, with a cylindrical opening on the top of the storage container, the open cylindrical extending down into the vase, but without access to ashes, while not extending to the bottom of the storage container, which holds a removable holder that may hold flowers or other items.

This application claims the benefit of provisional application No. 62/984,775, filed 3 Mar. 2020.

### FIELD OF THE INVENTION

The present invention relates to an urn system for ashes of deceased persons or pets which has the shape of a flower vase and contains an open cylindrical container that extends downward partway into the urn system that holds a removable holder for flowers or other items.

### BACKGROUND

There have been a variety of urns for holding cremated human and animal remains in a way that memorializes the deceased more than a standard urn. These include a wide variety of decorative memorial urns which can be stored indoors or outdoors in repository structures in permanent side-by-side niche arrangements formed in or along the walls of a building. An urn niche repository is sometimes referred to as a columbarium. U.S. Pat. No. 5,625,933, Cheryl G. Neuberger, Lindsay C. McClenny is an example of a decorative memorial urn.

Other patents such as U.S. Pat. No. 6,854,165, Daniel J Parker offer a device to memorializing a deceased by providing a lawn or garden sculpture comprising a pedestal and an ornament mounted atop the pedestal, the lawn or garden sculpture being adapted to contain cremated remains of the deceased, placing the cremated remains of the deceased in the lawn or garden sculpture and displaying the lawn or garden sculpture on a lawn or in a garden of a loved one of the deceased.

Another type of urn, U.S. Pat. No. 7,610,663, Raymond Keith Johnson, creates an urn that connects cremation ashes with living plants comprising a plant and at least one from the group consisting of cremated remains in a cavity of the plant and a location in the cavity of the plant that connects with the cremated remains. The device is meant to create a living, memorial for the deceased.

There are also many patents addressing storage units for holding cremated urns. Typical prior art storage systems may be seen in the Hancovsky patent, U.S. Pat. No. 4,607,417, which has an urn-like canister for storing and transporting cremated remains made of a molded plastic material. The canister is adapted to be inserted into one of an array of openings formed in a niche plate of a type having a recessed flange surrounding each niche opening.

What is missing from the market is an urn that can be used in home that can support living or artificial flowers, can be displayed as a decorative ornament, with a decorative appearance dramatically different than the one of a traditional urn. A new product is needed to addresses the fact that cremation urns are not often displayed in the home, first because the traditional looking urn makes people uncomfortable and second that the cremation urn cannot pay tribute to the deceased with flowers.

The present invention is designed to meet the need for a home display cremation urn is a vase shaped storage container for cremated remains with a sealed threaded screw cap on the bottom that opens to receive ashes, and a cylindrical opening on the top of the vase, but without access to ashes, the open cylindrical extending down into the vase for placement of a removable flower holder, holding flowers, either real or artificial.

### SUMMARY OF THE INVENTION

A container with a bottom access opening, that is closed when desired with a closing, apparatus, the closing apparatus allowing the vase urn to sit flat against the surface that the container is positioned on, and has on the top an opening to a cavity that extends part way downwards into the container, but without access to ashes, which holds a removable container fitted to the cavity that may hold flowers or other items. The preferred embodiment is a cremation urn that has the appearance of a standard flower vase (vase urn). The vase urn is formed of aluminum or other metals, ceramics and resins, and has a lacquer or painted coating to give the urn a decorative outward appearance The cremation urn has an opening in its base that is sealed with a threaded screw cap that allows the flower urn to sit flat against the surface the cremation urn is positioned on. The cremated remains may be placed within the vase urn via the opening in the base and then sealed inside with screw top or another closing device. The top of the vase urn has a neck with an opening on top of the urn, the opening on top of a cyclonical cavity which extends downward into the urn part way to the bottom of the urn, with the bottom of the cyclonical cavity sealed from the ashes. A separate removable container, possibly made of aluminum or other lightweight materials, fits into that cavity and may hold flowers or other items. The flower vase urn may also have a name plate if desired.

The advantages of the invention include that flowers may be placed within the holder and watered without risk of the water reaching or interacting with the cremated remains. The vase urn cavity for the flower holder and the compartment for the cremated remains are separate. Upon casual viewing the invention (vase urn) appears to be a flower vase, allowing the display of a cremation urn within the home that won't upset visitors or family members.

### PART NUMBER DESCRIPTION

100 flower vase cremation urn

102 top opening

104 bottom enclosure screw cap

106 threads on the screw cap

108 Compartment for cremation ashes

110 Cavity for flower holder

112 flower holder container

114 extending on top of flower holder

116 threads on base of flower urn

### BRIEF DESCRIPTION OF DRAWINGS

Note: Drawings are of the preferred embodiment

FIG. 1 is an illustrative representation of the flower vase cremation urn, in a ¾ front view.

FIG. 2 is an illustrative representation of the flower vase cremation urn showing the flower base, the flower holder and the threaded screw top on the base.

FIG. 3 is an illustrative cutaway representation of the flower vase cremation urn, showing the threaded base, the cavity for the flower holder, the compartment for the cremation ashes.

### DETAILED DESCRIPTION OF THE DRAWINGS

Note. Drawings are of the preferred embodiment

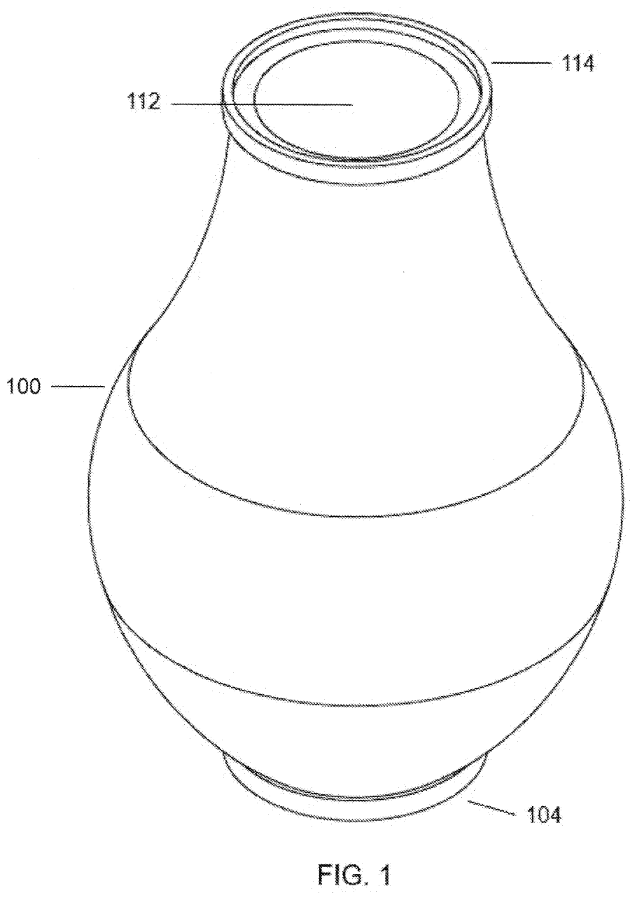

FIG. 1 is an illustrative representation of a ¾ front view of the flower vase cremation urn. The invention is a cremation urn 100 that has the appearance of a flower vase (vase urn). The top of the vase um is open to accept a flower holder container 112. The figure also shows the extended ring 114 on top of the flower holder which rests on the top of flower vase cremation urn 100 The vase urn may be made of aluminum and have a lacquer coating (not shown) for a decorative appearance.

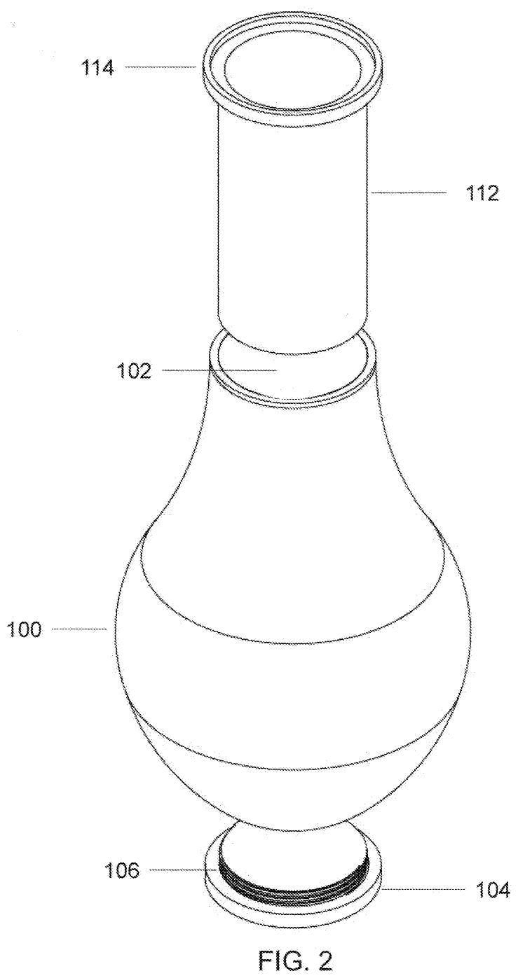

FIG. 2 is an illustrative representation of the flower vase cremation urn 100 showing the bottom of the base and the sealing device or threaded cap 104 that seals the bottom of the flower vase cremation urn 100, the threads on the threaded cap 106 and showing how the flower holder 112 slides into the top opening 102 of the flower vase cremation urn 100, as well as the extended ring 114 on the top of the flower holder container.

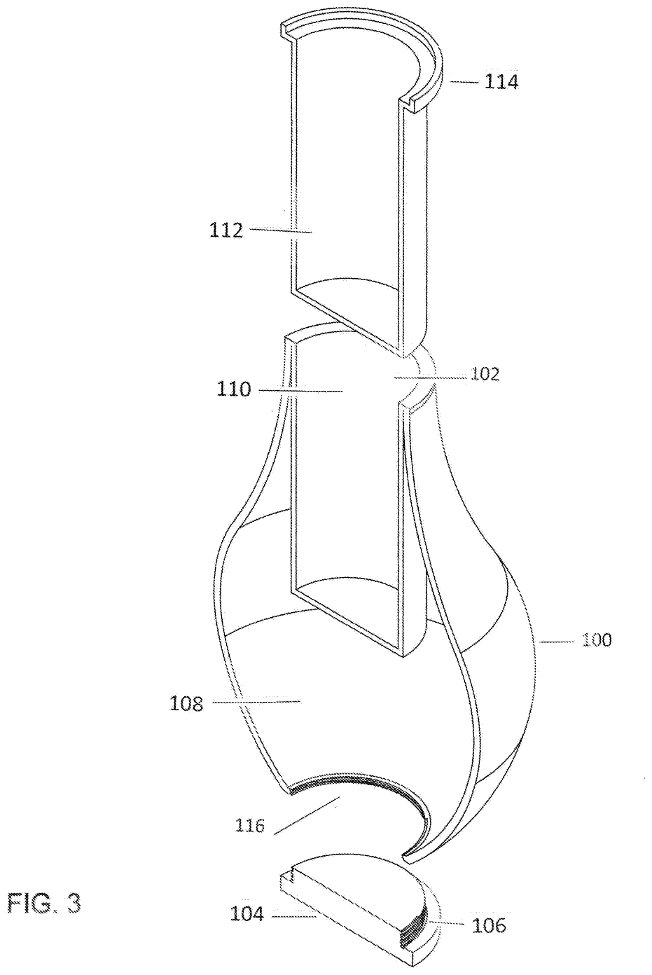

FIG. 3 is an illustrative representation of a cutaway of the flower vase cremation urn, 100 with the bottom sealing device or threaded cap 104 removed, showing the sealing cap threads 106. The figure also shows the threaded 116 section on the bottom of the flower vase cremation urn 100. The figure also shows the compartment 108 for which holds the ashes once the sealing device or threaded cap 104 is installed and the cavity for the flower holder 110 and the flower holder 112 with the extended ring 114. Other embodiments possible with this invention.
1. The urn does not need to be in a flower vase configuration, it only needs to have a design with four features, a compartment for the ashes, a method of sealing the bottom of die urn ash compartment which sits flat on the surface its positioned, a cavity extending downward from the top of the urn, an opening on the top of the cavity, and a removable container, designed to fit into the cavity. Any number of configurations fit the claimed features of this urn.
2. The vase can be made of aluminum, but also other metallic and non-metallic materials. The protective cover may be lacquer, or another decorative material.
3. The bottom edges on the urn may sit flat on the surface the urn is positioned on with the screw in cap being recessed from the urn's surface bottom edges.
4. The flower holder may be made out of a metallic material or non-metallic materials.

### USE OF THE INVENTION

The flower vase urn major compartment is for storing cremation ashes The compartment is accessed from the bottom of the flower vase urn through a large opening. The opening is sealed after the ashes are placed into the urn by a threaded storage cap or other sealing device. The threaded cap or sealing device is shielded from view when placed on a surface. The top of the flower vase urn has a neck with an opening to a cavity, sealed on the bottom, that extends part way into the flower vase urn that allows placement of a separate light weight flower holder made of aluminum or other lightweight materials, which is configured to fit into the cavity.

The flower vase urn allows flowers to be placed into the urn without risk of contamination, and it also offers a visually pleasing appearance for visitors or family members who might otherwise find viewing a cremation urn in a home unsettling.

I claim,

1. A storage container for cremated remains comprising:
a container having one or more walls for receiving cremated remains through an opening in the bottom;
a cavity area formed in the container, with the top of the cavity at the top of the container, for placement of a removable holder that fits into the cavity;
the opening in the bottom of the container closed with a threaded screw cap that is received by a threaded section residing in the container.

2. The storage container of claim 1 where the removable holder is included.

3. The storage container of claim 1 where the storage container has one wall in the shape of a flower vase.

4. The storage container of claim 3 where the walls are made of aluminum or other light-weight materials.

5. The storage container of claim 1 where the exterior of the walls are covered with lacquer or painted.

6. The storage container of claim 4 where the exterior of the walls are covered with lacquer or painted.

7. A storage container for cremated remains in accordance with claim 1 in which said container opening for cremated remains is recessed into a side of the container.

8. A storage container for cremated remains in accordance with claim 1 in which the container has a name display area.

9. A storage container for cremated remains in accordance with claim 1 in which said cap fasteners are threaded fasteners.

10. A storage container for cremated remains in accordance with claim 1 in which the container threaded screw cap is replaced by a plug or other sealing device.

11. A storage container for cremated remains in accordance with claim 1 in which the container is made of materials other than aluminum.

12. A storage container for created remains in accordance with claim 1 where the exterior of the walls a protective coating other than lacquer.
